(19) United States
(12) Patent Application Publication
(10) Pub. No.: US 2025/0308059 A1
(43) Pub. Date: Oct. 2, 2025

(54) SYSTEMS AND METHODS FOR DYNAMIC NON-LINE-OF-SIGHT TRACKING WITH A MOBILE PLATFORM

(71) Applicants: Sreenithy Chandran, Tempe, AZ (US); Shenbagaraj Kannapiran, Tempe, AZ (US); Suren Jayasuriya, Chandler, AZ (US); Spring Berman, Scottsdale, AZ (US)

(72) Inventors: Sreenithy Chandran, Tempe, AZ (US); Shenbagaraj Kannapiran, Tempe, AZ (US); Suren Jayasuriya, Chandler, AZ (US); Spring Berman, Scottsdale, AZ (US)

(73) Assignee: Arizona Board of Regents on Behalf of Arizona State University, Tempe, AZ (US)

(21) Appl. No.: 19/097,657

(22) Filed: Apr. 1, 2025

Related U.S. Application Data
(60) Provisional application No. 63/572,900, filed on Apr. 1, 2024.

(51) Int. Cl. G06T 7/70; G06T 5/50; G06T 7/246; G06V 20/17

(52) U.S. Cl. CPC G06T 7/70; G06T 5/50; G06T 7/246; G06V 20/17; G06T 2207/20221; G06T 2207/20224

(57) ABSTRACT

Unlike existing passive methods that estimate an object's position based on a single stationary planar surface, a computer-implemented framework for non-line-of-sight (NLOS) imaging accommodates scenarios where a camera, steered by a robot platform, captures varying sections of multiple planar surfaces. The framework includes a data preprocessing pipeline for enhancing the signal-to-noise ratio (SNR) and facilitating scene understanding. Recognizing that all visible surfaces could contain valuable NLOS scatter information, the framework includes a transformer-based network that leverages captures from all of these surfaces of varying aspect ratios to estimate the position over time of a hidden NLOS object.

### CROSS-REFERENCE TO RELATED APPLICATIONS

This is a U.S. Non-Provisional Patent Application that claims benefit to U.S. Provisional Patent Application Ser. No. 63/572,900 filed Apr. 1, 2024, which is herein incorporated by reference in its entirety.

### GOVERNMENT SUPPORT

This invention was made with government support under 1909192 awarded by the National Science Foundation. The government has certain rights in the invention.

### FIELD

The present disclosure generally relates non-line-of-sight (NLOS) imaging, and particularly to systems and methods for non-line-of-sight imaging with a dynamic camera setup.

### BACKGROUND

Implementing non-line-of-sight (NLOS) imaging on a moving camera remains an open area of research. Existing NLOS imaging methods rely on time-resolved detectors and laser configurations that require precise optical alignment, making it difficult to deploy them in dynamic environments.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is an illustration of an NLOS imaging task in which a vehicle equipped with a forward-facing camera moves in an occluded region while capturing images of multiple relay walls.

FIGS. 2A and 2B are a pair of diagrams showing an NLOS tracking framework for implementation by a computing device in communication with the camera of the vehicle of FIG. 1, including a plane extraction pipeline and a patch processing transformer architecture.

FIG. 3 is a simplified diagram showing an example computing device for implementation of the framework of FIGS. 2A and 2B.

FIG. 4A is an overhead view of a sample NLOS scene simulated using Blender showing a camera, an NLOS human character, and various sources of ambient lighting in the room; FIG. 4B shows samples of three sets of relay walls with different materials that were used for synthetic data generation; and FIG. 4C shows samples of eight human characters that were used for synthetic data generation.

FIG. 5A is a photograph showing an indoor real data collection setup with the drone in motion capturing images of the front visible wall while the NLOS object is hidden from the drone field-of-view (FOV); FIG. 5B is a photograph showing a side view of the same setup of FIG. 5A; and FIGS. 5C-5F are photographs of a sample set of various plane surfaces used within FOV regions within the dataset.

FIG. 6A is a front view of a customized vehicle, e.g., a drone, equipped with Intel RealSense camera for performing Visual Inertial Odometry (VIO); and FIG. 6B is a side view of the customized drone of FIG. 6A.

FIGS. 7A-7D are a series of graphical representations showing comparison of ground truth trajectories with trajectories generated using the framework of FIGS. 2A and 2B where the color of the lines indicate RMSE between the ground truth position and estimated position at time t.

FIGS. 8A-8C are a series of graphical representations, where FIG. 8A shows comparison of ground truth trajectory with trajectories generated using the framework of FIGS. 2A and 2B, as well as with trajectories generated using baseline methods, FIG. 8B shows corresponding Absolute Trajectory Error (ATE) vs. time, and FIG. 8C shows ATE box plot for the framework of FIGS. 2A and 2B compared with baseline methods.

FIG. 9 is a graphical representation showing an effect of plane quantity in a single sequence on trajectory error.

Corresponding reference characters indicate corresponding elements among the view of the drawings. The headings used in the figures do not limit the scope of the claims.

### DETAILED DESCRIPTION

The study of non-line-of-sight (NLOS) imaging is growing due to its many potential applications, including rescue operations and pedestrian detection by self-driving cars. However, implementing NLOS imaging on a moving camera remains an open area of research. Existing NLOS imaging methods rely on time-resolved detectors and laser configurations that require precise optical alignment, making it difficult to deploy them in dynamic environments.

The present disclosure outlines a framework, “PathFinder”, that applies a data-driven approach to NLOS imaging, and can be used with a standard RGB camera mounted on a small, power-constrained mobile robot such as an aerial drone. The framework is designed to accurately estimate a trajectory of a person who moves in a Manhattan-world environment while remaining hidden from the camera's field-of-view. The framework applies a novel approach to process a sequence of dynamic successive frames in a line-of-sight (LOS) video using an attention-based neural network that performs inference in real-time. The framework also includes a preprocessing pipeline that analyzes images from a moving camera which contain multiple vertical planar surfaces, such as walls and building facades, and extracts planes that return maximum NLOS information. The present disclosure further outlines validation of the framework on in-the-wild scenes using a drone for video capture, thus demonstrating low-cost NLOS imaging in dynamic capture environments.

### I. Introduction

Non-line-of-sight (NLOS) imaging is a technique that reconstructs an object that is not in the direct line-of-sight of a camera, using light scattered from one or more surfaces near the occluded object. This light undergoes multiple reflections and scatterings before it reaches a detector or camera, resulting in a low signal-to-noise ratio (SNR). To overcome this most systems use a combination of optical setups, powerful detectors, imaging algorithms, and/or deep learning techniques to estimate an underlying NLOS signal. This method has potential for a variety of practical applications, such as medical imaging, autonomous driving (e.g., detecting pedestrians and other vehicles around corners), localization of disaster victims, and search-and-rescue operations in hazardous environments. Most NLOS imaging demonstrations tend to be restricted to laboratory-scale setups, with minimal or no movement of the detector/acquisition system. However, for NLOS imaging to be deployed robustly in practice, it needs to accommodate dynamic movements of the detector, e.g., when it is mounted on a vehicle such as a mobile robot, and work in large-scale environments. Thus far, few works have addressed this problem, and existing approaches often utilize a portable radar sensor as the moving detector. In an effort to fill this gap, the present disclosure outlines a low-cost, practical solution to NLOS imaging (“PathFinder”) that can be deployed in dynamic capture environments using conventional consumer-grade cameras, without the need for specialized detectors.

NLOS imaging methods can be categorized as active, which make use of active illumination, or passive, which do not. Active imaging techniques usually direct a high-temporal-resolution light source (e.g., pulsed laser) into the NLOS region and use a time-resolved detector, such as a streak camera or Single Photon Avalanche Diodes (SPADs), to calculate the time of arrival of the reflected light pulse. Since these methods acquire very precise time data, they are suitable for high-resolution 3D object reconstruction. However, they can only be implemented using elaborate optical setups and require long acquisition times. In state-of-the-art Time-of-Flight systems, the scanning frequency can take up to several minutes, which is insufficient for real-time NLOS applications. In contrast to Time-of-Flight, researchers have also explored NLOS imaging using conventional cameras with lasers and/or spotlight illumination. However, this method still requires the use of a controlled illumination source, adding size, weight, and power when deployed on a robotic platform.

The present disclosure adopts a passive NLOS imaging approach, which is more suitable for the goals of the system. Passive NLOS imaging methods capture the visible light reflected from the hidden object to perform the imaging task. Due to the ill-posed nature of the problem, additional constraints and priors are often applied, including partial occlusion, polarization, and coherence. Recently, the use of data-driven scene priors for passive NLOS imaging has shown great promise. Tancik et al. used a convolutional neural network (CNN) to perform activity recognition and tracking of humans and a variational autoencoder to perform reconstructions. Sharma et al. presented a deep learning technique that can detect the number of individuals and the activity performed by observing the LOS wall. Wang et al. introduced PAC-Net, which utilizes both static and dynamic information about an NLOS scene. PAC-Net alternates between processing difference images and raw images to perform tracking. However, all of these methods are restricted to scenarios with a static camera.

Passive NLOS imaging methods are usually used for low-quality 2D reconstructions and localization tasks and often suffer from a low signal-to-noise ratio (SNR), a challenge previously addressed by subtracting the temporal mean of the video from each frame. However, this background subtraction technique is not feasible in dynamic capture environments.

To overcome this limitation, the present disclosure outlines a framework that implements a data preprocessing pipeline for enhancing the SNR and facilitating scene understanding. Moreover, unlike existing passive methods that estimate an object's position based on a single stationary planar surface, the framework accommodates scenarios where the camera, steered by a robot platform, captures varying sections of multiple planar surfaces. Recognizing that all visible surfaces could contain valuable NLOS scatter information, the framework includes a transformer-based network that leverages captures from all of these surfaces of varying aspect ratios to estimate the position of a hidden NLOS object. Components of the framework are trained with a mixture of both synthetic and real data.

Contributions of the present disclosure include a novel approach to NLOS imaging with a moving camera, employing a vision transformer-based architecture that uses example packing to simultaneously process multiple flat relay walls with different aspect ratios, thereby enhancing NLOS tracking performance. The disclosure further outlines demonstration of state-of-the-art results on real data to validate the approach, using a quadcopter for video capture. The data includes dynamic camera footage synchronized with high-resolution real NLOS object trajectories and camera poses.

### II. Problem Statement

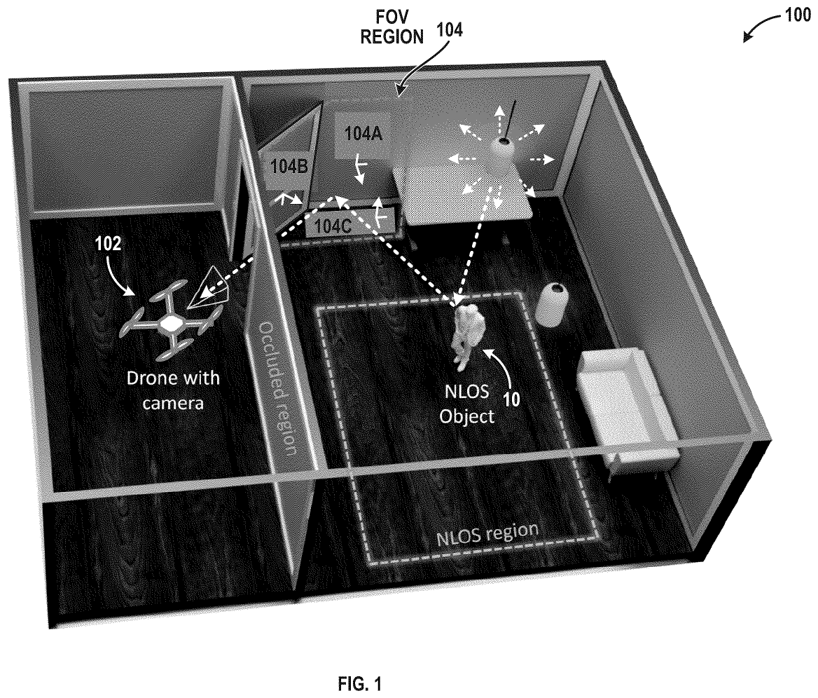

FIG. 1 shows an example illustration 100 of the NLOS imaging task addressed by the present method. A vehicle 102 (in this case, a quadrotor) equipped with a forward-facing camera moves in an occluded region while capturing images of multiple relay walls, here viewed through an open door, that are within its field-of-view (FOV region 104). In the example, the vehicle 102 can “see” a first planar surface 104A being a wall, a second planar surface 104B being an open door, and a third planar surface 104C being a floor. A person (NLOS object 10) walks around an area that is not visible to the drone (NLOS region). The present method estimates the person's 2D trajectory by leveraging the light scatter information in the drone's images of the relay walls. In one embodiment, the imaging setup includes an RGB camera mounted on a small mobile robot platform (e.g., vehicle 102) that observes multiple planar surfaces within its FOV. The goal of this method is to estimate a 2D position of a person (NLOS object 10) outside the camera's FOV and track their trajectory as they walk around an area that is not visible to the robot (e.g., walking within an NLOS region). White dotted lines in FIG. 1 illustrate how light reflected from the relay walls includes scattered information from the NLOS object, which is captured by the camera on the vehicle 102 as the camera “looks” at the relay walls.

The raw image of a visible planar surface captured by the camera is denoted by I∈ [symbol] ², which can be described as the output of a reflection function [symbol] :

$$I = ℱ ( X , V , N , ω )$$

where X∈ [symbol] ² is the ground-truth position of an NLOS object in a plane parallel to the floor; V∈ [symbol] ² is the NLOS object's velocity in this plane; N∈ [symbol] ³ is the unit vector normal to the surface that is viewed by the camera; and w refers to a set of environmental and material parameters that affect the appearance of the image, such as ambient noise and surface reflectivity. The direction of the normal vector with respect to the NLOS object determines the amount of NLOS scatter information that reaches the surface. In the example of FIG. 1, white arrows pointing away from each of the first planar surface 104A, the second planar surface 104B, and the third planar surface 104C indicate a direction of surface normal vector for each respective planar surface. The function [symbol] models the light transport of the setup, including information about how light interacts with the scene before reaching the camera. Generally, a goal of the present approach is to essentially “learn” the inverse function [symbol] ⁻¹ in order to compute estimates of X(t) and V(t) for t∈[0,T] given some final time T. These estimates are denoted as X′(t) and V′(t), respectively. In the study, for simplicity, it was assumed that there is only a single occluded person and that the scene has a Manhattan-world configuration.

### III. NLOS Tracking Pipeline

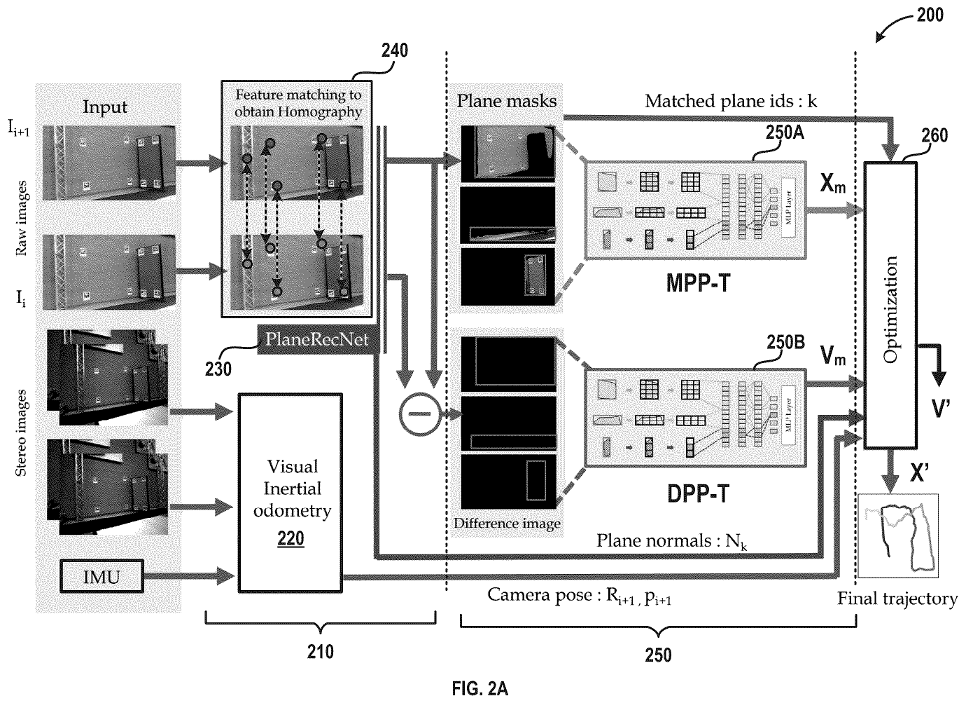

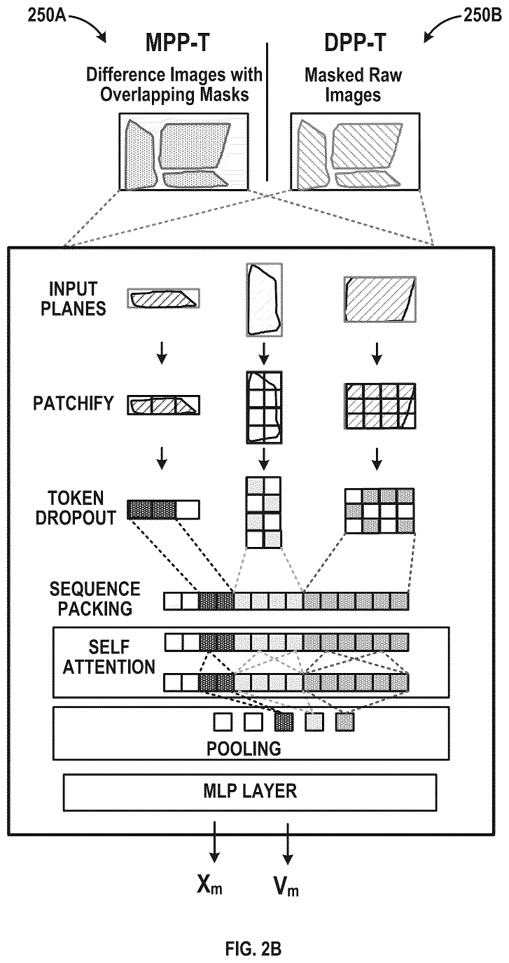

FIGS. 2A and 2B illustrate a NLOS tracking framework 200 which can be implemented at a computing device in communication with a camera onboard a vehicle (such as vehicle 102 of FIG. 1). Given the dynamic nature of the camera in this scenario, the NLOS tracking framework 200 commences with a plane extraction pipeline outlined in Section III.A herein. This process operates on the raw data stream alongside additional inputs from the capture system, yielding masked, separated planes that are instrumental in NLOS human tracking. Subsequently, the output(s) of the plane extraction pipeline feeds into an NLOS transformer network of the NLOS tracking framework 200, tasked with estimating the 2D position X and velocity V of the individual in different planes. A description of the network architecture is provided in Section III.B herein with reference to FIG. 2B. Furthermore, the NLOS tracking framework 200 jointly optimizes the NLOS transformer network with data from the plane extraction pipeline to refine estimates of X and V using data from multiple planes in a data-driven manner, as outlined in Section III.C.

The various stages of the NLOS tracking framework 200 are depicted in FIG. 2A. The NLOS tracking framework can include a plane extraction pipeline 210, which performs important pre-processing steps such as acquiring plane information from image data and estimating camera pose. As shown, inputs to the NLOS tracking framework 200 include raw image data (e.g., RGB image data) and stereo image pair data from an image capture device onboard the vehicle 102, and inertial measurement data from an inertial measurement unit (IMU) onboard the vehicle 102. This information is provided to a Visual Inertial Odometry (VIO) module 220 which can estimate a camera pose. A learning-based plane detection module 230 (such as PlaneRecNet) generates plane masks from consecutive frames of raw image data, each plane mask indicating a plane which is detectable within a field-of-view of the vehicle. Homography from a feature matching module 240 is applied to the plane masks, constructing difference images and obtaining k plane identifiers (IDs).

Following the plane extraction pipeline 210, a transformer network 250 takes the raw and difference images along with the plane masks and outputs position and velocity estimates Xₘ and Vₘ. A raw image at time step i+1 is provided as input to a first transformer network (Multi-Resolution Planes-Patch Transformer, “MPP-T” 250A) and a corresponding difference image between time steps i and i+1 is provided as input to a second transformer network (Difference Plane-Patch Transformer, “DPP-T” 250B), respectively yielding estimates Xₘ and Vₘ. FIG. 2B shows the details of a patch processing transformer architecture which can embody one or more of MPP-T 250A and DPP-T 250B as labeled in FIG. 2A.

During training, an optimization layer 260 jointly optimizes the MPP-T 250A and the DPP-T 250B using estimates Xₘ and Vₘ, along with the camera pose (which can change over time as the vehicle 102 moves) from the VIO module 220, plane IDs, and unit vector normal to each plane from the learning-based plane detection module 230. This enables the NLOS tracking framework 200 to model different aspects of the reflection function [symbol] so that it can accurately infer position and velocity of the NLOS object based on how the planes appear within the image data captured by the camera.

### III.A Plane Extraction Pipeline

To achieve NLOS imaging with a dynamic camera, the plane extraction pipeline 210 can use visual inertial odometry (VIO) to obtain pose estimates of the moving camera and feature matching to identify anchor points in the image. The plane extraction pipeline 210 utilizes raw color camera images, stereo image pair data, and IMU data as input. The ground-truth trajectory of the person is obtained from motion capture data. Stereo pair images and synchronized IMU data are used to perform VIO which provides reliable camera pose estimates (e.g., using a multi-state constant Kalman filter (MSCKF)). When the camera is mounted on an aerial drone, the VIO output can also be used to localize the drone while in flight.

The VIO module 220 is used to obtain the camera's positions pᵢ, and pᵢ₊₁ and orientations Rᵢ and Rᵢ₊₁ in the global coordinate system at time steps i and i+1, respectively. Consider the raw color images Iᵢ and Iᵢ₊₁ that are captured at these times. A main function of the plane extraction pipeline 210 is to monitor all planar surfaces that can serve as intermediary relay walls to carry out effective NLOS human tracking by extracting image patches from these surfaces to pass along to the downstream NLOS localization network. To accomplish this, the learning-based plane detection module 230 can extract plane masks that correlate with planar surfaces identifiable within the image data. Note that in some examples, the learning-based plane detection module 230 does not track planes or assign plane IDs. As such, the feature matching module 240 (e.g., a scale-invariant feature transform (SIFT) module) can be implemented for plane tracking between consecutive images and their difference images, estimating the homography for stitching. Plane IDs are determined based on mask overlap in stitched images, with new IDs assigned to non-overlapping planes and IDs of non-visible planes discarded.

As such, outputs of the plane extraction pipeline 210 can include a camera pose Rᵢ₊₁ and pᵢ₊₁ from the VIO module 220, plane normals Nₖ and plane masks from learning-based plane detection module 230, and plane IDs k and difference image(s) from feature matching module 240.

Inputs provided to the transformer network 250 following the plane extraction pipeline 210 can include the plane masks, plane IDs k, raw color images, and difference images.

### III.B NLOS-Patch Network

The transformer network 250 is designed to process the raw images and predict the 2D position estimate Xₘ and velocity estimate Vₘ of the NLOS object in each plane m in a sequence of M example planes represented within the camera coordinate system. These estimates are for time step i+1, with Xₘ updated based on the assumption that Vₘ at time step i is constant over the small time interval between time steps. As shown in FIG. 2A, the transformer network 250 is a parallel transformer network including MPP-T 250A which computes Xₘ and DPP-T 250B which computes Vₘ, m=1, . . . , M. In some examples, the MPP-T 250A and DPP-T 250B are vision transformers (ViTs), which have been shown to have advantages over convolutional networks for a variety of tasks. As shown in FIG. 2B, in a ViT, an image is divided into patches, and each patch is linearly transformed into a token. These tokens are then passed into attention modules for learning. Generally, the input is reshaped into a square matrix and then divided into a fixed number of grids. However, this input reshaping and subdivision is highly inefficient for this purpose, since the visual feed of a mobile robot will vary with each successive observation as it navigates the environment, given its restricted field-of-view. Thus, the transformer network 250 should determine position estimate Xₘ and velocity estimate Vₘ using incomplete images of planes and patches of various sizes and locations.

Additionally, since the passive NLOS tracking problem already suffers from low SNR due to the presence of ambient lighting, the goal is to leverage all available spatial intensity information captured from the LOS surfaces in the learning problem. Toward this end, the MPP-T 250A and the DPP-T 250B can be adapted from the NaViT network, proposed by Dehghani et al., which packs multiple patches from different images with varying resolutions into a single sequence. They demonstrate that example packing, wherein multiple examples are packed into a single sequence, results in improved performance and faster training. This is a popular technique in natural language processing. The main components of the MPP-T 250A and the DPP-T 250B are outlined herein and are illustrated in FIG. 2B.
a) Patchify: Given a raw image Iᵢ at time step i, a detected plane in Iᵢ with plane ID k, and a corresponding plane mask image denoted by M_{i,k}, a masked plane Im_{i,k} is obtained as a product of raw image I; and plane mask image M_{i,k}. The masked planes Im_{i,k} and Im_{i+1,k} at time steps i and i+1 and the difference image ΔIm_{i+1,k} between them are passed into the transformer network 250 (where the MPP-T 250A receives the raw image I; and plane mask image M_{i,k}, and the DPP-T 250B receives the masked planes Im_{i,m} and Im_{i+1,n} and the difference image ΔIm_{i+1,k} between the masked planes).

The masked planes at each time step are then packed into a single batch. Each image in this batch is split into patches, then a token dropout is applied to the patches, and the resulting sequences of masked planes are obtained. The plane IDs associated with each plane, described herein, are also converted into a batched format. This procedure is also applied by the DPP-T 250B to the difference images ΔIm_{i+1,k}, which can be used by the DPP-T 250B to estimate the NLOS object's velocity V between time steps i and i+1. Thus, the velocity Vₘ of the NLOS object between two time steps i and i+1 can be directly related to the difference image ΔIm_{i+1,k}.
b) Factorized Positional Embedding: To process images of arbitrary resolutions, factorized absolute position embeddings ow and on are used for the width and height of the patches, respectively, as proposed in Dehghani et al. The factorized 2D absolute positional embeddings are each summed with the learned patch embedding, ϕₚ.

c) Masked Self-Attention: To learn attention relationships between planes with identical IDs, self-attention masks are employed within the MPP-T 250A as well as the DPP-T 250B. Masked pooling at the end of the attention layers ensures that token representations are pooled within each example. The output of this pooling is a single vector for each of the M example planes in the sequence, which is finally passed into a simple Multi-Layer Perceptron (MLP) head including two fully-connected layers. The transformer network 250 outputs the 2D position estimate Xₘ from the MPP-T 250A and 2D velocity estimate Vₘ from the DPP-T 250B, where m=1, . . . , M, for M total planes and for time step i+1. In some examples, if say, m masked planes are present in a batch, the output of the transformer network 250 can be an m×4 matrix that includes a 2D position and velocity estimate with respect to each plane.
d) Loss Function: For end-to-end training, an objective is to minimize the mean squared error (MSE) between a ground truth position X and estimated position Xₘ, denoted by MSE(X,Xₘ), as well as a ground truth velocity V and estimated velocity Vₘ, denoted by MSE(V,Vₘ), at each time step. To achieve this, a loss function £ takes into account the estimates from all M example planes, so that the network learns from the diverse information provided by multiple reflective planes (where a is a constant weighting parameter that balances the relative importance of the position and velocity losses):

$$ℒ = {\sum }_{m = 1}^{M} ( MSE ( X , {X}_{m} ) + α MSE ( V , {V}_{m} ) ) .$$

### III.C Optimization

The estimates Xₘ and Vₘ in each example plane m at time step i+1 are passed from the transformer network 250 into an optimization layer 260 to produce final position and velocity estimates X′ and V′. For each example plane m, the estimates Xₘ and Vₘ are transformed from the camera coordinate system to the global coordinate system using a transformation matrix Tₘ∈ [symbol] ^{3×4} corresponding to the plane (where the transformation of the camera coordinate system relative to the global coordinate system is affected by the camera pose for a time step as obtained from the VIO module 220). Estimates in global coordinates are denoted as Xₘ^{g} and Vₘ^{g}, and can include 3D position (Xₘ^{g}=[x, y, z]) and velocity (Vₘ^{g}=[\dot{x}, \dot{y}, ż]). For a 2-D example implementation, since the NLOS object is modeled as moving in the (x, y) plane of the global coordinate system, the z coordinate of Xₘ^{g} and ż coordinate of Vₘ^{g} are set to 0. Let m₁, m₂, and m₃ respectively denote indices of the largest, second-largest, and third-largest example planes. Reflections of position estimates Xₘ_{₂}^{g} and Xₘ_{₃}^{g} across planes m₂ and m₃ are denoted respectively by Xₘ_{₂}^{g,r} and Xₘ_{₃}^{g,r}. These reflected position estimates (in global coordinates) are computed as the output of a reflection function [symbol] _{g}(Xₘ^{g}, Vₘ^{g}, Nₘ, Tₘ), m∈{m₂, m₃}, where Nm is the unit vector normal of example plane m as obtained by the learning-based plane detection module 230. The reflection function represents the composition of a series of operations that model how light interacts with the NLOS object and a reflective plane before reaching the camera. During training of various components of the NLOS tracking framework 200, an optimization problem computes the position estimate X′ and the velocity estimate V′ that minimize the following cost function:

$$J ( {X}^{′} , {V}^{′} ) = {\sum }_{m ∈ \{ {m}_{2} , {m}_{3} \}} {‖ {X}_{{m}_{1}}^{g} - {ℱ}_{g} ( {X}_{m}^{g} , {V}_{m}^{g} , {N}_{m} , {T}_{m} ) ‖}^{2} .$$

### III.D Computer-Implemented System

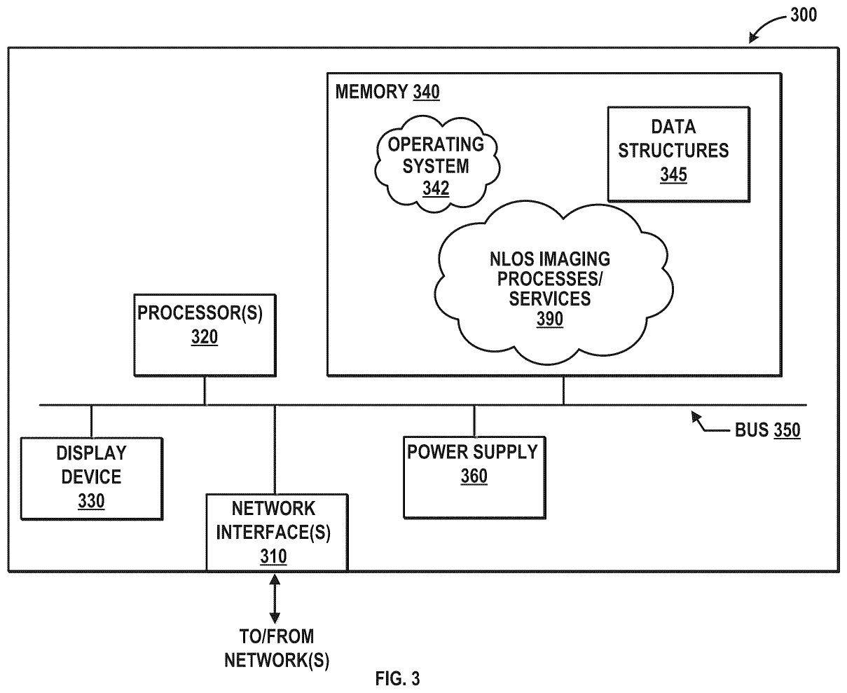

FIG. 3 is a schematic block diagram of an example device 300 that may be used with one or more embodiments described herein, e.g., as a component of a computing device onboard or otherwise in communication with an image capture device and an inertial measurement unit associated with the vehicle 102 of FIG. 1, implementing aspects of NLOS tracking framework 200 as shown in FIGS. 2A and 2B.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.). Device 300 can also include or otherwise communicate with a display interface device 330 which can include one or more input/output devices that enable a user to input data, and to view or otherwise access output data. Input/output devices can include but are not limited to a monitor, a touch-screen, a speaker, a keyboard, a mouse, and the like, which can be used to interact with controls of the vehicle 102 or image capture devices onboard the vehicle 102, displaying information about the NLOS object being tracked such as one or more of the estimated position and the estimated velocity of the object, selecting a NLOS object for tracking, and the like.

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360. Further, input data which can be provided to device 300 can include image data (raw and stereo-paired) from an image capture device onboard the vehicle 102 as well as IMU data from an inertial measurement unit onboard the vehicle 102.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the framework 200 and the methods outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include NLOS imaging processes/services 390, which can include aspects of the methods and/or implementations of various modules described herein, especially NLOS tracking framework 200. Note that while NLOS imaging processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to a model or an organization of interrelated software components/functions. Further, while the NLOS imaging processes/services 390 is shown as a standalone process, those skilled in the art will appreciate that this process may be executed as a routine or module within other processes.

### IV. Datasets

### IV.A Synthetic Dataset

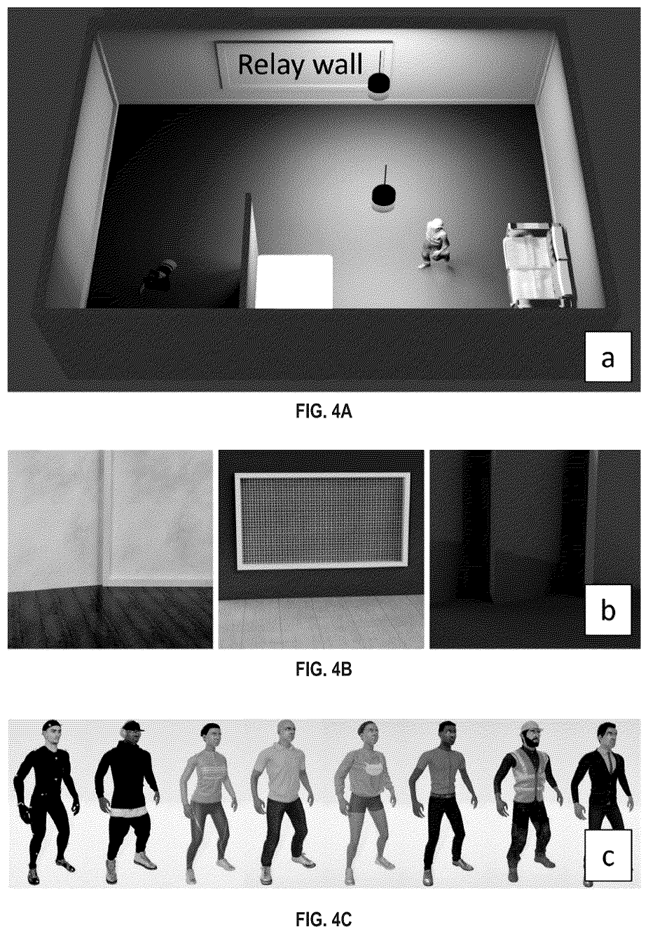

We generated synthetic data to train the NLOS-Patch network using Cycles, Blender's physics-based ray tracing renderer. We simulated diverse indoor NLOS imaging scenarios in an effort to create to a rich training dataset that enhances the network's robustness in complex real-world scenarios. In each simulation, the camera moved along a random trajectory in 3D space, and the NLOS object was an animated human character, created in Mixamo, who walked with different gaits and postures in a random path along the ground plane. Trajectories for the 6D camera pose and the 2D position of the human character were each defined by selecting ten random points in a specific region and connecting them with a Bezier curve. To increase the variance in the dataset, we simulated 20 different configurations of objects in the scene, eight different human characters, and different numbers, orientations, and materials of relay walls in the FOV region (see FIGS. 4A-4C). To enhance the realism of the synthetic data, we also simulated real-world noise at the pixel level in the synthetic data creation process.

The Robot Operating System (ROS) was integrated with Blender scripts through the use of Blender addons, enabling easy collection of the trajectories of the human character and camera from their respective ROS topics. The rendering for frames of size 256×256 pixels took around 3 s per frame.

While the present disclosure discusses a custom dataset which was used to train, refine and validate the systems outlined herein, other existing datasets may be developed and used as well.

### IV.B Real-World Dataset and Hardware Configuration

We also trained the NLOS-Patch network using real-world data, which we collected from trials with 5 human subjects across 10 large-scale indoor scenes.

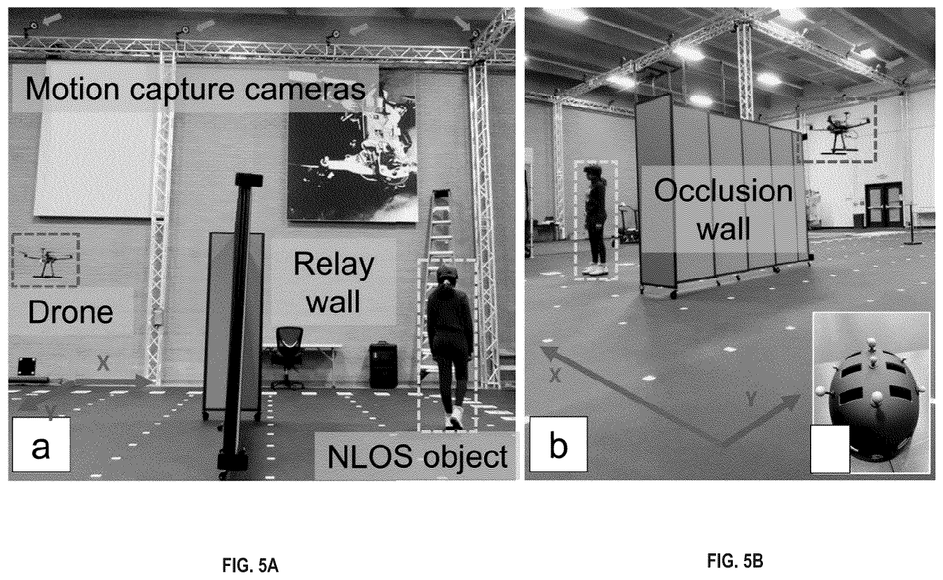

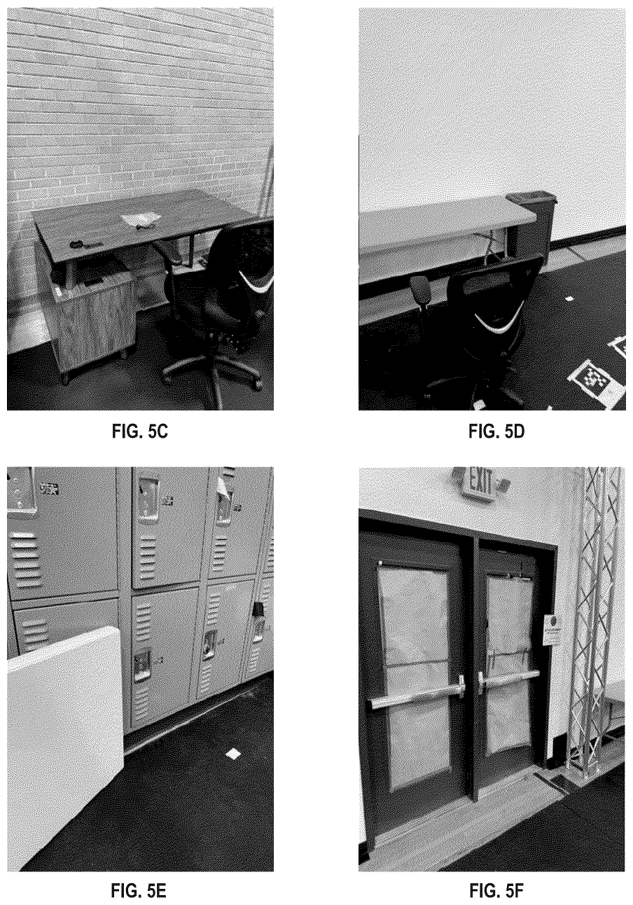

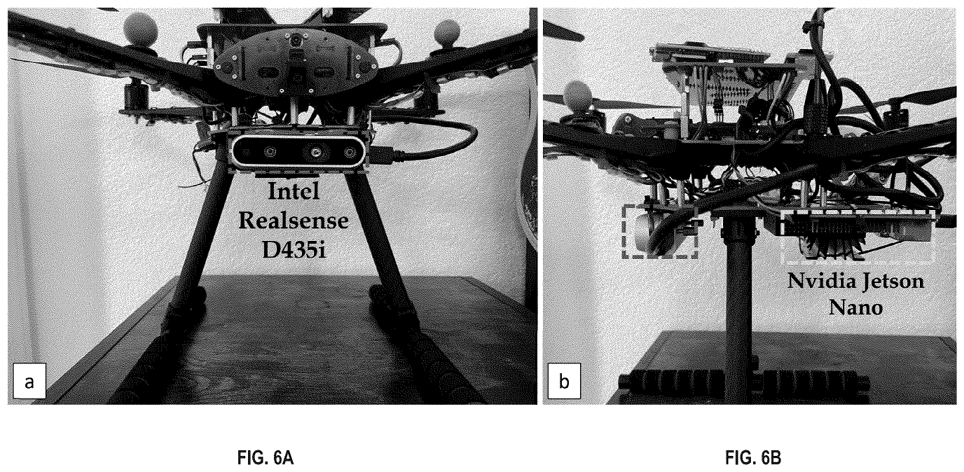

The data collection setup is shown in FIGS. 5A-5F, with images of sample FOV regions shown in FIGS. 5C-5F. We built a versatile aerial drone (FIGS. 6A and 6B) using standard off-the-shelf components to serve as the mobile camera platform. The drone is equipped with an Intel RealSense depth camera D435i, which has a 2-MP RGB camera with a resolution of 1920×1080 pixels and a FOV of 69°×42°. The camera operates with a rolling shutter mechanism and can capture images at a rate of 30 FPS. The drone is also equipped with a stereo pair of cameras with a resolution of 1280×720 pixels and a combined FOV of 87°×58°, which can capture images at 90 FPS. The onboard synchronized IMU is also integrated into our data collection methodology, providing visual inertial odometry.

The indoor testing space was equipped with 68 OptiTrack Prime 17 W motion capture cameras with a 70°-degree horizontal FOV and a 1.7-MP (1664×1088 pixel resolution) image sensor, which captured position data at a rate of 120 FPS with <0.5 mm precision. We used this motion capture system to track infrared (IR) reflective markers that were attached to the drone and to a helmet worn by the participants (FIG. 5B). In this way, we obtained precise ground-truth data for the occluded person's positions and the drone's poses.

To collect the images captured by the cameras onboard the drone, the Intel RealSense camera was connected to an NVIDIA Jetson Nano computer on the drone, which recorded the raw data onto the NVMe SSD storage. The data were then synchronized with ROS and extracted after the trials as ROSbag files for further processing. The data collection was done offline because of significant latency in transmitting the raw camera and stereo pair image data in real-time over WiFi, due to the bandwidth requirements (250 Mb/s).

### V. Experiments

In this section, we describe the NLOS-Patch network training process, the metrics used to evaluate the tracking performance of our method, and other ablations. We quantify and discuss our method's performance on our collected synthetic and real-world datasets.

### V.A Training Procedure

The NLOS-Patch network was trained with both synthetic and real data, and inference was done on both types of data. The entire dataset was split into non-overlapping training and validation datasets. Although the Intel RealSense camera streams at 30 FPS, the person (NLOS object) does not move to 30 different positions within a 1-second time interval, so we chose every 15th frame for our datasets. During the training step, we passed the three largest planes generated by the plane extraction pipeline (Section III-A) into the network. All values of the NLOS object's position were normalized by the size of the room. We employed a transformer network with a patch size of 64, an attention dimension size of 1024, a depth of 4, and a dimension head of 128. Additionally, we set the dropout rate for the tokenized input to 0.4 and the embedded dropout to 0.2.

Inference Speed: The PlaneRecNet algorithm and our VIO method both have an inference speed of 8-9 FPS. For an instance of processing three planes in a single sequence, the NLOS-Patch network has an inference time of 3000 FPS on an NVIDIA RTX A6000 graphics card. Hence, our NLOS tracking method is capable of real-time inference.

### V.B Quantitative Tracking Results

To assess the tracking performance of our method, we measured the Root Mean Square Error (RMSE) between the NLOS object's ground-truth position X(t) and its estimate X′(t), denoted by RMSEₓ, and the RMSE between the NLOS object's ground-truth velocity V(t) and its estimate V′(t), denoted by RMSEᵥ. We compared the performance of our method on both synthetic and real-world data to that of the following other passive, deep learning-based NLOS imaging methods as baselines. Table I reports the resulting RMSE values (average±standard deviation) over 50 trials of duration 128 s each. We note that our method is the first passive NLOS tracking method that uses a dynamic camera and multiple relay walls, whereas the selected baseline methods use a stationary camera and a single relay wall.

TABLE I
Tracking performance of our method (PathFinder) with
and without modifications, and baseline methods.

| | | RMSEₓ (mm) | RMSEᵥ (mm/s) |
|---|---|---|---|
| Baselines | PAC-Net | 54.73 ± 24.78 | 1.22 ± 0.42 |
| | He et al. | 72.65 ± 53.32 | — |
| | Tancik et al. | 92.97 ± 64.87 | — |
| PathFinder | w/o velocity | 21.53 ± 2.64 | — |
| (Real Data) | w/o optimization | 29.14 ± 2.79 | 1.34 ± 0.53 |
| | One patch | 16.72 ± 3.09 | 1.13 ± 0.46 |
| | All patches | 15.94 ± 2.38 | 1.38 ± 0.34 |
| PathFinder | w/o velocity | 26.75 ± 2.93 | — |
| (Synthetic Data) | w/o optimization | 27.93 ± 1.92 | 1.39 ± 0.33 |
| | One patch | 19.98 ± 2.24 | 1.43 ± 0.38 |
| | All patches | 18.05 ± 2.03 | 1.26 ± 0.39 |

PAC-Net (Wang et al.): Comparing our method to PAC-Net helps to assess the advantages of our transformer-based architecture and attention mechanism in handling dynamic camera scenarios. Similar to our method, PAC-Net alternately processes raw images and difference images using two recurrent neural networks. However, this method is trained on single static planar walls. We trained the PAC-Net network to run inference using the full captures of raw images in our input dataset. As shown in Table I, PAC-Net yielded an average RMSEₓ≈55 mm and average RMSEᵥ=1.2 mm/s.

He et al.: This method uses a deep learning-based approach to image and track moving NLOS objects using RGB images captured under ambient illumination. It employs a CNN architecture followed by fully-connected layers. We re-implemented their proposed network architecture and trained it on our input dataset. This method produced an average RMSEₓ≈73 mm.

Tancik et al.: This method uses a CNN regression network that is designed to learn from the scattered light information in the environment to achieve NLOS object tracking and activity recognition. This method produced an average RMSEₓ=93 mm.

Compared to these baseline methods, our method without any modifications (the “All patches” rows in Table I) produced the lowest average RMSEₓ for both real-world data (˜16 mm) and synthetic data (˜18 mm). RMSEᵥ values could not be computed for the He et al. and Tancik et al, methods because their network architectures only process raw images, not difference images.

We also tested the performance of our method with the following modifications:
w/o velocity: In this version of our method, we trained the transformer network without including the velocity loss MSE(V, V′) in the loss function. Thus, there is a single transformer architecture that processes the masked planes, and it is trained by minimizing the position loss MSE(X, X′). The average RMSEₓ for this method was ˜22 mm for real-world data and ˜27 mm for synthetic data.
w/o optimization: This version of our method does not perform the optimization step that is critical to ensure accurate position estimates. Instead, the estimated position X′ is computed as the average of the position estimates for the three largest planes output by the plane extraction pipeline across the patches in each example sequence in the NLOS-Patch network. The average RMSEₓ for this version is significantly higher than that for the unmodified version, for both the synthetic and real-world data.
One Patch: In this version of our method, only the largest plane output by the plane extraction pipeline is passed into the transformer network. This version yields slightly worse performance in terms of average RMSEₓ than the unmodified version for both the synthetic and real-world data, demonstrating the advantage of processing multiple planes simultaneously in our method.

### V.C Qualitative Visualization of Tracking Performance

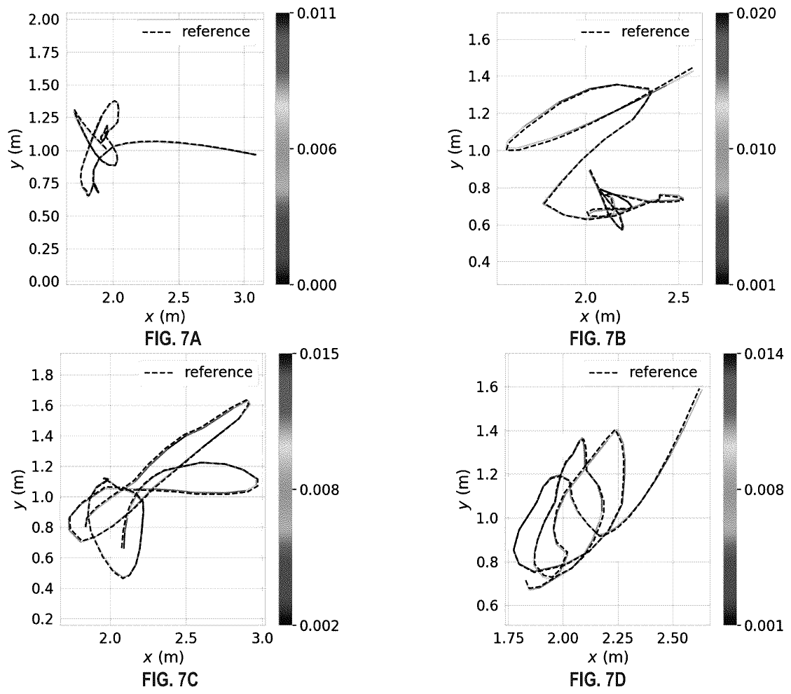

FIGS. 7A-7D plot several trajectories X′(t) estimated by our method against the corresponding ground-truth trajectories X(t), with the RMSEₓ indicated along the estimated trajectories. These plots illustrate how closely the estimated path from our method follows the actual path of the NLOS object.

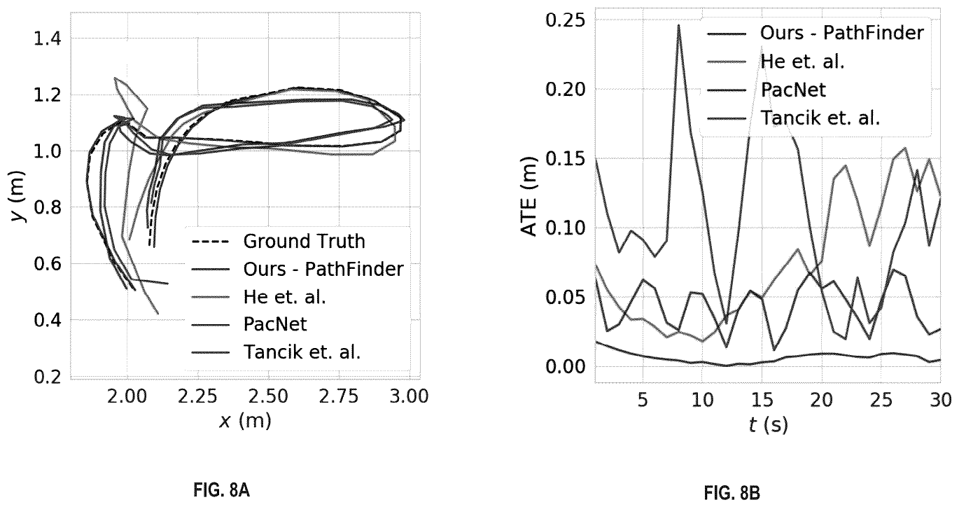

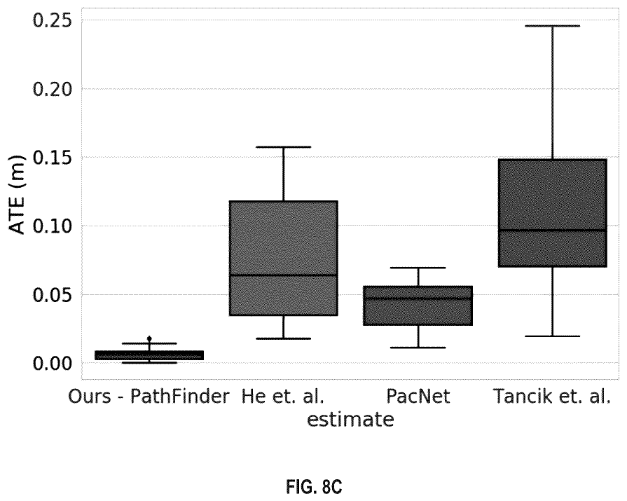

In FIG. 8A, we compare one estimated trajectory from our method to the ground-truth trajectory and trajectories estimated by the PAC-Net, He et al., and Tancik et al, methods. The estimate from our method closely aligns with the ground-truth trajectory, whereas the other estimates exhibit greater deviations from ground-truth. Moreover, our method produces consistently accurate position estimates over time, even when the camera movements are aggressive, whereas the other methods (which use a stationary camera) exhibit large variations in accuracy over time. This is evident from FIGS. 8B and 8C, which show the absolute trajectory error (ATE) over time and a box plot of the ATE for each method. Our method exhibits a consistently low ATE, while the ATEs of the other methods are higher and display large fluctuations.

### V.D Effect of Number of Planes on Performance

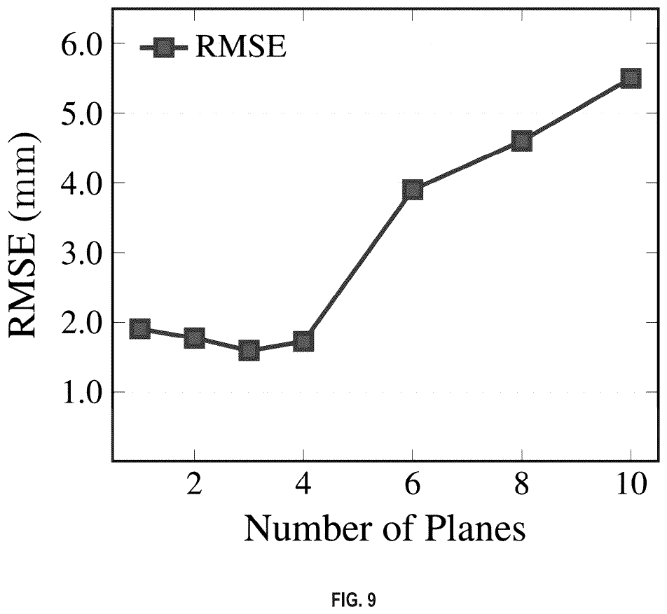

When the drone moves through the environment in our real-world trials, its camera captures numerous planes, but most of them tend to be small (trivial) and do not help improve tracking performance. Intuitively, we know that packing more planes per sequence in our NLOS-Patch network scales up the cost of attention if we keep the hidden dimension of the transformer constant. Using our real-world data, we studied the effect on RMSE x of packing different numbers of masked planes into a sequence, without changing the hidden dimensions. The results of this ablation study are plotted in FIG. 9, which shows that using three planes results in the lowest RMSEₓ value. Therefore, we chose to use the largest three planes as a suitable trade-off between performance and cost of attention.

### V.E Effect of Camera Motion on Performance

We assessed our method's performance under abrupt camera movements through tests in which a camera assembly, including an Intel RealSense camera fixed between a Jetson Nano board and a LiPo battery, was manually moved in our real-world NLOS imaging setup. For motion capture tracking, 18 IR markers were attached to the camera assembly. Given the coordinate system in FIG. 5B, in one trial, the camera was rapidly rotated about the y-axis at a rate of one full revolution per second for 10 s, and in the other two trials, the camera was translated back and forth 1 meter along either the x or y axis at about 1 m/s for 10 s.

Sudden camera rotation disrupts the feature detector, causing inaccurate difference images. However, our dual-stream network architecture mitigates the effect of noisy or sparse difference image data on its position estimates. Table II shows relatively low values of RMSE x and RMSEᵥ for each test, indicating satisfactory performance.

TABLE II
Performance of our method with camera rotation about
the y-axis and translation along the x and y axes.

| | RMSEₓ (mm) | RMSEᵥ (mm/s) |
|---|---|---|
| Rotation (y) | 37.27 ± 5.35 | 1.89 ± 0.76 |
| Translation (x) | 22.12 ± 2.46 | 1.48 ± 0.51 |
| Translation (y) | 19.74 ± 2.38 | 1.04 ± 0.42 |

### V.F Effect of Camera Sensor on Performance

To investigate the impact of camera sensor characteristics on our method's performance, we collected and analyzed raw color images from four different cameras: Sony A6000 Mirrorless, Intel RealSense D435i, IDS UI-3250CP-M-GL, and IMX214. These cameras vary in specifications such as megapixels, image resolution, FPS, and shutter types (rolling and global). The Intel RealSense and IMX214 cameras were mounted on drones, while the Sony A6000 and IDS cameras were operated manually. To enhance data integration, we paired raw images with IMU readings, obtained either directly from the cameras or through external IMUs. We calibrated the camera-IMU pairs using the Kalibr toolbox, following established methodologies to accurately determine the extrinsic relationships.

We tested our method in our real-world setup with a 1-minute image sequence captured using each of the four cameras. As shown in Table III, the tracking performance was similar across all four cameras. This consistency can be attributed to our NLOS-Patch network's ability to process planes of varying sizes and aspect ratios through example packing, as detailed in Section III-B.

TABLE III
Tracking performance of our method, tested on different
rolling shutter and global shutter cameras.

| | Sony A6000 | Intel D435i | IDS camera | IMX214 |
|---|---|---|---|---|
| RMSEₓ (mm) | 13.46 ± 2.24 | 13.92 ± 2.73 | 14.63 ± 2.82 | 15.41 ± 2.56 |
| RMSEᵥ (mm/s) | 1.84 ± 0.45 | 1.47 ± 0.39 | 1.21 ± 0.35 | 1.38 ± 0.44 |

### VI. Discussion

The present disclosure outlines a novel data-driven approach for dynamic non-line-of-sight (NLOS) tracking using a mobile robot equipped with a standard RGB camera. To the best of our knowledge, this is the first NLOS tracking approach to handle dynamic camera environments. Our method leverages attention-based neural networks to accurately estimate the 2D trajectory of an occluded person in real-world Manhattan environments. Our NLOS tracking pipeline includes a plane extraction procedure that analyzes images from a moving camera to identify planes carrying maximum NLOS information. We employ novel transformer-based networks to process successive frames and estimate the person's position. The networks are capable of simultaneously processing multiple flat relay walls of different aspect ratios, which enhances the tracking performance. We validated our approach on both synthetic and real-world datasets, demonstrating state-of-the-art results in dynamic NLOS tracking. Our method achieved an average positional RMSE of 15.94 mm on real data, outperforming existing passive NLOS methods and highlighting its effectiveness in practical scenarios. Additional sensor data may be integrated to further improve the accuracy and robustness of NLOS tracking.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a vehicle including an image capture device, the image capture device being operable to capture image data of a field-of-view across a plurality of frames, the field-of-view including one or more planar surfaces that collectively relay light scatter information about a position of an object that is occluded from the field-of-view of the image capture device; and
a processor in communication with the image capture device and a memory, the memory including instructions executable by the processor to:
extract a plane mask correlating with a planar surface of the one or more planar surfaces identifiable within the plurality of frames of the image data; and
generate one or more of an estimated position and an estimated velocity of the object with respect to the planar surface by application of the plane mask and the image data as input to a transformer network, the transformer network being trained to estimate one or more of the position of the object or a velocity of the object based on the light scatter information from the one or more planar surfaces observable within the image data.

2. The system of claim 1, the memory further including instructions executable by the processor to:
generate the estimated position of the object with respect to the planar surface of the one or more planar surfaces by application of the plane mask and a frame of the plurality of frames of the image data as input to a Multi-Resolution Planes-Patch Transformer of the transformer network, the Multi-Resolution Planes-Patch Transformer being trained to estimate the position of the object based on the light scatter information from the one or more planar surfaces observable within the image data.

3. The system of claim 2, the memory further including instructions executable by the processor to:
transform, by the Multi-Resolution Planes-Patch Transformer, a plurality of patch tokens from one or more masked plane images associated with the one or more planar surfaces into a token sequence, the Multi-Resolution Planes-Patch Transformer being a vision transformer network; and
generate the estimated position of the object by application of one or more self-attention layers and a multi-layer perceptron layer of the Multi-Resolution Planes-Patch Transformer to the token sequence.

4. The system of claim 1, the memory further including instructions executable by the processor to:
construct, for the planar surface, a difference image between a first masked plane image associated with a first frame of the image data and a second masked plane image associated with a second frame of the image data, the first masked plane image being a combination of a first plane mask for the planar surface and the first frame of the image data, and the second masked plane image being a combination of a second plane mask for the planar surface and the second frame of the image data; and
generate an estimated velocity of the object with respect to the planar surface of the one or more planar surfaces and across the first frame and the second frame by application of the difference image as input to a Difference Plane-Patch Transformer of the transformer network, the Difference Plane-Patch Transformer being trained to estimate the velocity of the object based on the difference image.

5. The system of claim 4, the memory further including instructions executable by the processor to:
transform, by the Difference Plane-Patch Transformer, a plurality of patch tokens from one or more difference images associated with the one or more planar surfaces into a token sequence for the second frame, the Difference Plane-Patch Transformer being a vision transformer network; and
generate the estimated velocity of the object by application of one or more self-attention layers and a multi-layer perceptron layer of the Difference Plane-Patch Transformer to the token sequence.

6. The system of claim 1, the memory further including instructions executable by the processor to:
track, based on homography from feature matching applied to the image data, the planar surface across two or more frames; and
determine a plane identifier for the planar surface.

7. The system of claim 1, the memory further including instructions executable by the processor to:
extract, by application of a learning-based plane detection to the image data, a unit vector normal for the planar surface of the one or more planar surfaces identifiable within the image data.

8. The system of claim 1, the memory further including instructions executable by the processor to:
access inertial measurement data from an inertial measurement unit associated with the vehicle; and
estimate a camera pose with respect to a global coordinate system for the image capture device based on the inertial measurement data.

9. The system of claim 1, the memory further including instructions executable by the processor to:
jointly train a Multi-Resolution Planes-Patch Transformer and a Difference Plane-Patch Transformer of the transformer network using the estimated position, the estimated velocity, a camera pose with respect to a global coordinate system for the image capture device, a plane identifier for each planar surface of the one or more planar surfaces, and a unit vector normal for each planar surface of the one or more planar surfaces.

10. A system, comprising:
a processor in communication with an image capture device and a memory, the memory including instructions executable by the processor to:
extract a plane mask correlating with a planar surface of one or more planar surfaces identifiable within a plurality of frames of image data captured by the image capture device, the image data featuring the one or more planar surfaces collectively relaying light scatter information about a position of an object that is occluded from the image capture device;
generate one or more of an estimated position and an estimated velocity of the object with respect to the planar surface by application of the plane mask and the image data as input to a transformer network, the transformer network being trained to estimate one or more of the position of the object or a velocity of the object based on the light scatter information from the one or more planar surfaces observable within the image data; and
display, at a display device in communication with the processor, one or more of the estimated position and the estimated velocity of the object.

11. The system of claim 10, the memory further including instructions executable by the processor to:
generate the estimated position of the object with respect to the planar surface of the one or more planar surfaces by application of the plane mask and a frame of the plurality of frames of the image data as input to a Multi-Resolution Planes-Patch Transformer of the transformer network, the Multi-Resolution Planes-Patch Transformer being trained to estimate the position of the object based on the light scatter information from the one or more planar surfaces observable within the image data.

12. The system of claim 11, the memory further including instructions executable by the processor to:
transform, by the Multi-Resolution Planes-Patch Transformer, a plurality of patch tokens from one or more masked plane images associated with the one or more planar surfaces into a token sequence, the Multi-Resolution Planes-Patch Transformer being a vision transformer network; and
generate the estimated position of the object by application of one or more self-attention layers and a multi-layer perceptron layer of the Multi-Resolution Planes-Patch Transformer to the token sequence.

13. The system of claim 10, the memory further including instructions executable by the processor to:
construct, for the planar surface, a difference image between a first masked plane image associated with a first frame of the image data and a second masked plane image associated with a second frame of the image data, the first masked plane image being a combination of a first plane mask for the planar surface and the first frame of the image data, and the second masked plane image being a combination of a second plane mask for the planar surface and the second frame of the image data; and
generate an estimated velocity of the object with respect to the planar surface of the one or more planar surfaces and across the first frame and the second frame by application of the difference image as input to a Difference Plane-Patch Transformer of the transformer network, the Difference Plane-Patch Transformer being trained to estimate the velocity of the object based on the difference image.

14. The system of claim 13, the memory further including instructions executable by the processor to:
transform, by the Difference Plane-Patch Transformer, a plurality of patch tokens from one or more difference images associated with the one or more planar surfaces into a token sequence for the second frame, the Difference Plane-Patch Transformer being a vision transformer network; and
generate the estimated velocity of the object by application of one or more self-attention layers and a multi-layer perceptron layer of the Difference Plane-Patch Transformer to the token sequence.

15. The system of claim 10, the memory further including instructions executable by the processor to:
track, based on homography from feature matching applied to the image data, the planar surface across two or more frames; and
determine a plane identifier for the planar surface.

16. The system of claim 10, the memory further including instructions executable by the processor to:
extract, by application of a learning-based plane detection to the image data, a unit vector normal for the planar surface of the one or more planar surfaces identifiable within the image data.

17. The system of claim 10, the memory further including instructions executable by the processor to:
access inertial measurement data from an inertial measurement unit associated with the image capture device; and
estimate a camera pose with respect to a global coordinate system for the image capture device based on the inertial measurement data.

18. The system of claim 10, the memory further including instructions executable by the processor to:
jointly train a Multi-Resolution Planes-Patch Transformer and a Difference Plane-Patch Transformer of the transformer network using the estimated position, the estimated velocity, a camera pose with respect to a global coordinate system for the image capture device, a plane identifier for each planar surface of the one or more planar surfaces, and a unit vector normal for each planar surface of the one or more planar surfaces.

19. A method, comprising:
extracting, at a processor in communication with a memory and an image capture device, a plane mask correlating with a planar surface of one or more planar surfaces identifiable within a plurality of frames of image data captured by the image capture device, the image data featuring the one or more planar surfaces collectively relaying light scatter information about a position of an object that is occluded from the image capture device;
generating, by the processor, an estimated position of the object by application of the plane mask and the image data as input to a Multi-Resolution Planes-Patch Transformer, the Multi-Resolution Planes-Patch Transformer being trained to estimate the position of the object based on the light scatter information from the one or more planar surfaces observable within the image data;
generating, by the processor, an estimated velocity of the object across a first frame and a second frame of the plurality of frames by application of a difference image between the first frame and the second frame as input to a Difference Plane-Patch Transformer, the Difference Plane-Patch Transformer being trained to estimate the velocity of the object based on the difference image; and
displaying, at a display device in communication with the processor, one or more of the estimated position and the estimated velocity of the object.

20. The method of claim 19, further comprising:
jointly training the Multi-Resolution Planes-Patch Transformer and the Difference Plane-Patch Transformer using the estimated position, the estimated velocity, a camera pose with respect to a global coordinate system for the image capture device, a plane identifier for each planar surface of the one or more planar surfaces, and a unit vector normal for each planar surface of the one or more planar surfaces.
